(19) United States
(12) Patent Application Publication
(10) Pub. No.: US 2015/0242848 A1
(43) Pub. Date: Aug. 27, 2015

(54) SYSTEM AND METHOD FOR INTERNET CONSUMER TERMINAL (ICT)

(71) Applicant: Tom Hughes, Rolling Hills, CA (US)

(72) Inventor: Tom Hughes, Rolling Hills, CA (US)

(21) Appl. No.: 14/529,447

(22) Filed: Oct. 31, 2014

Related U.S. Application Data
(60) Provisional application No. 61/943,153, filed on Feb. 21, 2014.
(60) Provisional application No. 62/006,617, filed on Jun. 2, 2014.

(51) Int. Cl. G06Q 20/38; G06Q 20/12

(52) U.S. Cl. CPC G06Q 20/382; G06Q 20/12

(57) ABSTRACT

Systems and methods are provided which enable superior security in web transactions by allowing the use of DCWP/DCP/CCP in internet transactions, where such were previously only available in retail transactions. In some implementations, a mobile device such as a smart phone enables the payment of such transactions at web merchant sites and other internet websites. In one implementation, a mobile device may be coupled to an internet consumer terminal module which allows secure processing. In another implementation, a mobile device may include an integral internet consumer terminal module. In either case, systems and methods according to present principles enable a mobile device to act as a consumer terminal that can be used for payment by DCWP/DCP/CCP.

### CROSS-REFERENCE TO RELATED APPLICATIONS

This application claims benefit of priority of U.S. Provisional Patent Application Ser. No. 61/943,153, filed Feb. 21, 2014, and entitled “Terminal In a Phone”, and Ser. No. 62/006,617, filed Jun. 2, 2014, and entitled “SYSTEM AND METHOD FOR INTERNET CONSUMER TERMINAL (ICT)”, both of which are owned by the assignee of the present application and herein incorporated by reference in their entireties.

### FIELD OF THE INVENTION

The invention is in the field of commerce, and in particular, in the field of credit and debit card transactions.

### BACKGROUND

Internet commerce is ubiquitous. Currently there are approximately 2,650,000,000 global online consumers and millions of global web merchants. Consequently, credit and debit card usage is also ubiquitous, in web and other online transactions. Currently none of these consumers can pay over the internet without having to type in credit or debit card data at web merchant sites or with website intermediary services, storing card information.

Referring to the prior art FIG. 1, a typical credit card transaction 10 is illustrated. The user 12 provides credit card data to a web merchant 14, and the web merchant in turn provides goods or services to the user 12. The credit card data is typically stored at the web merchant 14, and the same is provided to a credit card processor 16 and in turn to the card issuer 18, from which the web merchant receives funds for the purchase. The card issuer 18 (or processor 16) bills the user 12 on their credit card statement.

However, the credit card data is sent by the user to the web merchant with no guarantee as to how the data will be stored or protected. Thus, security in web transactions is less than security at, e.g., retail “brick-and-mortar” establishments, because in brick-and-mortar establishments, the retailer can verify the presence of the physical credit or debit card, can check the name on the card against a form of identification, can use a camera to record who is using the card, and so on. In internet and web transactions, none of these checks can be performed. As noted, as users perform transactions on the internet, their credit card information is generally stored with the web merchant, increasing the availability (and a vulnerability) of credit card information to potential hackers.

Efforts have been made to make card processing more secure. For example, debit card with PIN” (“DCWP”) provides the same security as cash from the perspective of the web merchant. And “credit card present” (“CCP”) is the equivalent of a web merchant being paid in a face-to-face transaction by the consumer. Each of these is a fairly secure type of transaction. However, such have not been implemented in consumer online transactions, such as those transacted by internet sellers and web merchants.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

Systems and methods according to present principles meet the needs of the above in several ways. First, systems and methods according to present principles enable the security of face-to-face transactions to be conducted online. In one implementation, systems and methods according to present principles provide superior security in web transactions by allowing the use of DCWP and CCP in internet transactions, as well as debit card present (DCP), where such were previously only available in certain brick-and-mortar retail transactions.

In one implementation described, systems and methods according to present principles include a mobile device such as a smart phone that enables the payment of DCWP/DCP/CCP at web merchant sites and other internet websites. To do so, the systems and methods employ a card reader which can be attached to a mobile device, or which can be manufactured to be integral with the mobile device. The systems and methods may also employ a PIN pad, which can also be attached to the mobile device, or the systems and methods can use the mobile device's keyboard (either physical or touchscreen) for input of a PIN. It should be understood that systems and methods according to present principles may work with other configurations as well, so long as required data as described may be entered into a mobile device such as a smart phone. For example, wireless forms of data transfer may be used.

In one specific implementation, an Internet consumer terminal (“ICT”) module device may be coupled to an off-the-shelf mobile phone, with the ICT module device, within the context of the transaction, keeping any card data from being stored at the web merchant. In particular, the ICT (which may operate in conjunction with the optional PIN pad) includes a chip such as a DES (data encryption standard) chip (which is a physical chip) which encrypts the PIN, and security such as DUKPT (Derived Unique Key Per Transaction) to protect the consumer data. In this way, systems and methods according to present principles can enable a mobile device to act as a consumer terminal that can be used for payment by and as DCWP/DCP/CCP.

In a second implementation, the security chip such as the above-noted DES hardware chip may be built within the mobile device, and thus the ICT module device is integral therewith. Again, the PIN pad may be a touchscreen pad, a physical device keypad, or a detachable one. To obtain card information, as with the first implementation, a card reader may be attached to the mobile device or may be formed integrally therewith.

In either implementation (and in variations within implementations), the card reader may be such as to read magnetic stripes as well as “chip and pin” types of cards. Once the cards are read, their information may be stored in memory by the ICT (first implementation) or by the mobile device (second implementation). And once the cards are read, the card reader may be removed (if external) and not used again until a new card is to be read.

In yet another implementation, an ICT module device may be coupled to a user's computer, to enhance security of web and internet transactions conducted thereon. For example, the ICT module device may be coupled via a USB or other such connection (including wireless connections) to various devices including desktop computers, laptop computers, notebook computers, tablet computers, phablet computers, and the like.

In one aspect, the invention is directed towards a device for performing online commerce in a secure fashion, including: an internet consumer terminal module device, configured to signally couple to a mobile device, the internet consumer terminal module device configured to transmit credit or debit card data to a credit card processor upon a transaction conducted by the mobile device with an online merchant; wherein the internet consumer terminal module device further includes a physical chip configured to encrypt credit or debit card data to a level sufficient for the credit card processor to complete the transaction.

Implementations of the invention may include one or more of the following. The chip made include a DES chip, and the encryption may include DUKPT. The device may further include a card reader formed integrally with the internet consumer terminal module device. The internet consumer terminal module device may further include a port configured to attach to a card reader. The device may further include means for input of a personal identification code, which in some implementations may be a user interface of the internet consumer terminal module device. The means may also include a user interface of the mobile device and/or a port for a detachable pin pad.

In yet another aspect, the invention is directed towards a device for performing online commerce in a secure fashion, including: a mobile device including an internet consumer terminal module, the mobile device configured to transmit credit or debit card data to a credit card processor upon a transaction conducted by the mobile device with an online merchant; where the internet consumer terminal module further includes a physical chip configured to encrypt credit or debit card data to a level sufficient for the credit card processor to complete the transaction.

Implementations of the invention may include one or more of the following. The chip made include a DES chip, and the encryption may include DUKPT. The device may further include a card reader formed integrally with the mobile device. The mobile device may further include a port configured to attach to a card reader. The device may further include means for input of a personal identification code, which in some implementations may be a user interface of the mobile device. The means may also include a user interface of the mobile device and/or a port for a detachable pin pad.

In another aspect, the invention is directed towards a method for performing online commerce in a secure fashion using a consumer mobile device, including: using one of the devices noted above, identifying and authenticating a user with the internet consumer terminal module device; using the same device, identifying and authenticating the internet consumer terminal module device with a credit card processor server; and if both authentications are successful, allowing the internet consumer terminal module device to complete a transaction with the credit card processor server.

In yet another aspect, the invention is directed towards a method for enabling the performance of online commerce in a secure fashion using a hosting server in communication with a plurality of consumer mobile devices, including: on a hosting server, identifying and authenticating a user employing a device as noted above; receiving an encrypted request for an authorization for a transaction from an Internet merchant, the transaction requested by the user; decrypting the request, or causing the decryption of the request; determining if the requested transaction should proceed; and transmitting the determination from the hosting server to the Internet merchant.

Advantages of the invention may include, in certain embodiments, one or more of the following. In some implementations, systems and methods according to present principles allow the use of DCWP/DCP/CCP in internet transactions, where such were previously only available in retail transactions, increasing the security of such transactions to the same level as retail transactions. As another example, in some implementations the transaction price (typically a percentage) may drop significantly because of the lessened risk to the parties involved. For example, where the web merchant may previously have paid a 2.5% transaction fee, the fee may drop to 2% or less if the transaction can be verified to be a DCWP/DCP/CCP-type transaction, as little or no liability to the web merchant inures.

Other advantages will be understood from the description that follows, including the figures and claims.

This Summary is provided to introduce a selection of concepts in a simplified form. The concepts are further described in the Detailed Description section. Elements or steps other than those described in this Summary are possible, and no element or step is necessarily required. This Summary is not intended to identify key features or essential features of the claimed subject matter, nor is it intended for use as an aid in determining the scope of the claimed subject matter. The claimed subject matter is not limited to implementations that solve any or all disadvantages noted in any part of this disclosure.

### BRIEF DESCRIPTION OF THE DRAWINGS

FIG. 1 is a logical diagram showing data flow in a prior art credit card transaction.

FIG. 2 is a logical diagram showing data flow in a transaction according to one implementation of present principles.

FIG. 3(A) is a schematic diagram illustrating a first device according to present principles.

FIG. 3(B) is a diagram illustrating a second device according to present principles.

FIG. 4 is a flowchart illustrating a method according to present principles.

FIG. 5 is another flowchart illustrating a method according to present principles.

FIG. 6 is a logical diagram showing process steps in a transaction according to an implementation of present principles. FIG. 6(A) illustrates registration and FIG. 6(B) illustrates a transaction

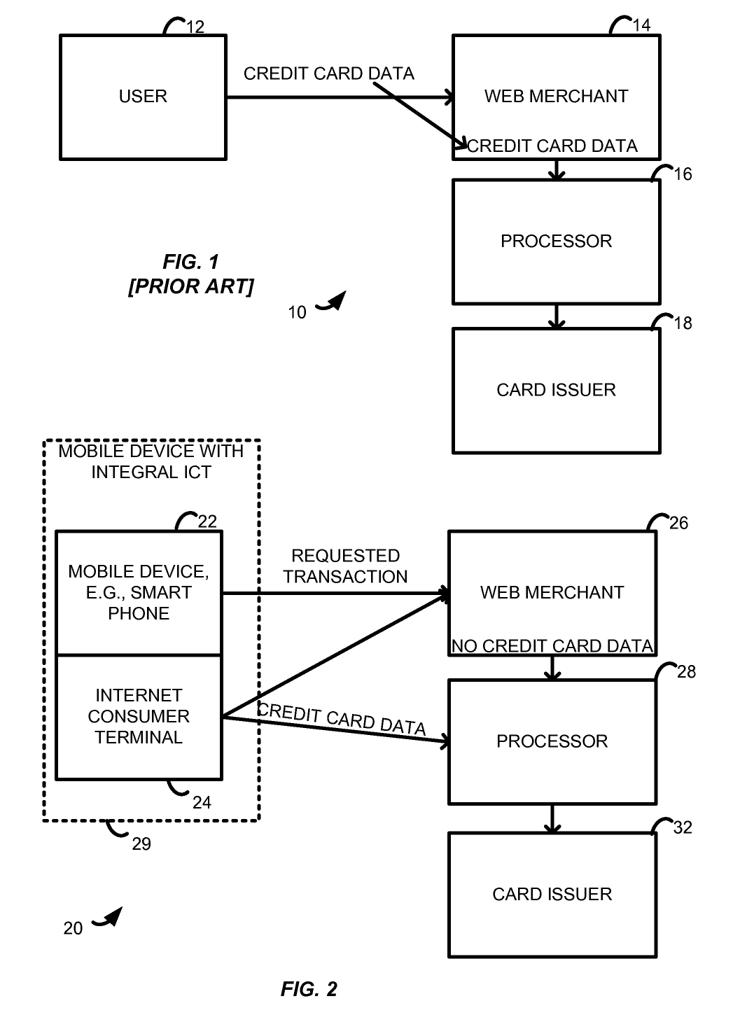

Like reference numerals refer to like elements throughout. Elements are not to scale unless otherwise noted.

### DETAILED DESCRIPTION

Systems and methods according to present principles provide superior security in web transactions by allowing the use of enhanced security types, e.g., DCWP/DCP/CCP, in internet transactions, where such were previously only available in certain retail brick-and-mortar transactions.

In particular, and referring to the system 20 of FIG. 2, a user with a mobile device 22 conducts a transaction with a web merchant 26. In this case, the user 22 employs an internet consumer terminal 24 (ICT) and thus credit card data is transmitted directly to a processor 28 which in turn performs its part of the transaction with a card issuer 32. The combination of the mobile device 22 with the terminal 24 may be replaced with a mobile device with an integral terminal noted as device 29.

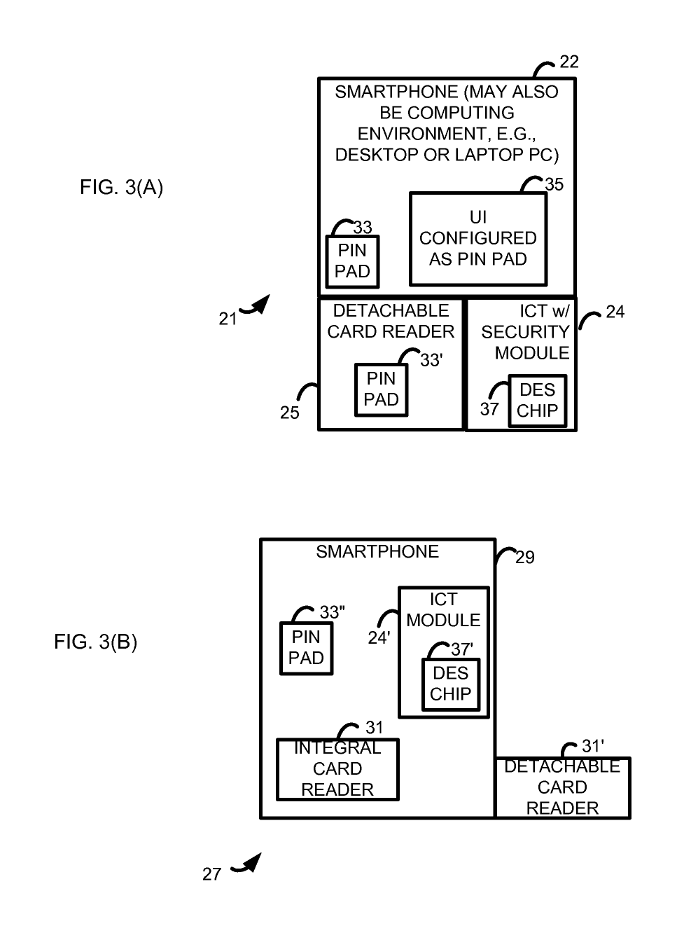

In more detail, and referring to FIG. 3A, systems and methods according to present principles include a device 21 which in turn may include a mobile device 23 such as a smart phone. To accomplish present principles, the device 21 further includes other devices, modules, and/or features. For example, the device 21 may include a detachable card reader 25 which can be attached to smart phone 23, e.g., in a removable fashion, or which can be manufactured to be integral with the mobile device (see, e.g., FIG. 3B below). The device 21 may also include a PIN pad 33, for user entry of a personal identification number or code, which can be attached to the mobile device, or the systems and methods can use an aspect of the mobile device's UI 35, e.g., a keyboard (either physical or touchscreen), as a pin pad for input of a PIN. The pin pad may alternatively be implemented by a pin pad 33′ disposed on the detachable card reader 25 or on an ICT module 24 described below.

In particular, the device 21 along with card reader 25 and (soft or physical) PIN pad 33 may further include (and be removably coupled to) an ICT module 24. In some implementations, the ICT security module 39 may be combined with, e.g., the card reader 25 or a separate physical pin pad. The ICT security module 39 may include a chip 37 such as a DES chip which may serve to encrypt the PIN, and the encryption may include security such as DUKPT (Derived Unique Key Per Transaction). The DES chip is a physical chip (it is noted in this regard that currently software-only systems are not allowed by VISA/MasterCard to encrypt PINs). In this way, systems and methods according to present principles enable a mobile device to conduct an online transaction as a physical storefront would, by scanning the physical card, encrypting the card information, and transmitting the data to the processor, and thus the device 21 acts like a consumer terminal that can be used for payment by DCWP and CCP.

In a second embodiment, and referring to FIG. 3(B), a mobile device 29 such as a smart phone may include an integral ICT module 24′, again with a security chip 37′ such as the above-noted DES hardware chip. As with the embodiment of FIG. 3A, the PIN pad may be a touch screen pad or may be the “regular” mobile device keypad (collectively shown as pin pad 33″). To obtain card information, as with the first embodiment, a card reader 31′ may be attached to the device 29 (and such may further include a pin pad) or an integral card reader 31 may be formed as part of the mobile device 29.

In either embodiment (and in variations within embodiments) the card reader may be configured to read magnetic stripes as well as “chip and pin” types of cards. Once the cards are read, their information may be stored in memory by the ICT (first embodiment (FIG. 3A)) or by the mobile device (second embodiment (FIG. 3B)). Once cards are read, the card reader may be removed (if external) and not used again until a new card is to be read.

In yet another embodiment, an ICT module device may be coupled via USB or other direct or wireless connection to a computing environment such as a desktop computer, a laptop computer, a tablet computer, a phablet computer, or the like, to enable users to conduct online web and internet transactions in a secure way as described above and below.

The devices of FIGS. 3A and 3B allow and enable the payment of DCWP and CCP at web merchant sites and other internet websites, and the same advantageously keep card data from being stored at the web merchant.

### DCWP

For DCWP applications, the debit card can be inserted into the card reader. This may also apply to a debit card with chip following EMV protocols. In either case, information about the debit card, including information from the stripe or the chip, as well as the PIN, can be stored on the mobile device, or alternatively can be required to be received every time a transaction is requested. Put another way, the card may be required to be inserted, and the PIN typed in, every time a transaction is performed, or alternatively the same may be reused using information and data stored on the mobile device and/or ICT. At some point, however, the card may be “run” so as to enable the mobile device to receive and store the needed data about the card, thus necessitating at least temporary use of a card reader.

The PIN and/or card swipe information may be encrypted and stored on the mobile device using, e.g., DES and/or DUKPT.

### CCP

As with debit cards, credit cards can also be inserted into the card reader. And similarly, this may also apply to credit cards with chips following EMV protocols. In either case, information about the credit card, including information from the stripe or the chip, can be stored on the mobile device, or alternatively can be required to be received every time a transaction is requested. Put another way, the card may be required to be inserted every time a transaction is performed, or alternatively the same may be reused using information and data stored on the mobile device. At some point, however, the card may be “run” so as to enable the mobile device to receive the needed data about the card, thus necessitating at least temporary use of a card reader.

Using the above systems and methods according to present principles, mobile devices may be employed to enable the equivalent of a DCWP or CCP transaction at a web merchant site, but the systems and methods leave no card data with the web merchant, as opposed to current systems in which “typed in” credit and debit card numbers are stored, or can be stored, at web merchant sites, deleteriously allowing hackers to steal such information. In particular, the ICT may interact with the web merchant at their site, but even in so doing the ICT may interact directly with a secure processor for the provision of payment information, such as card information, such that the card information is never present at the web merchant.

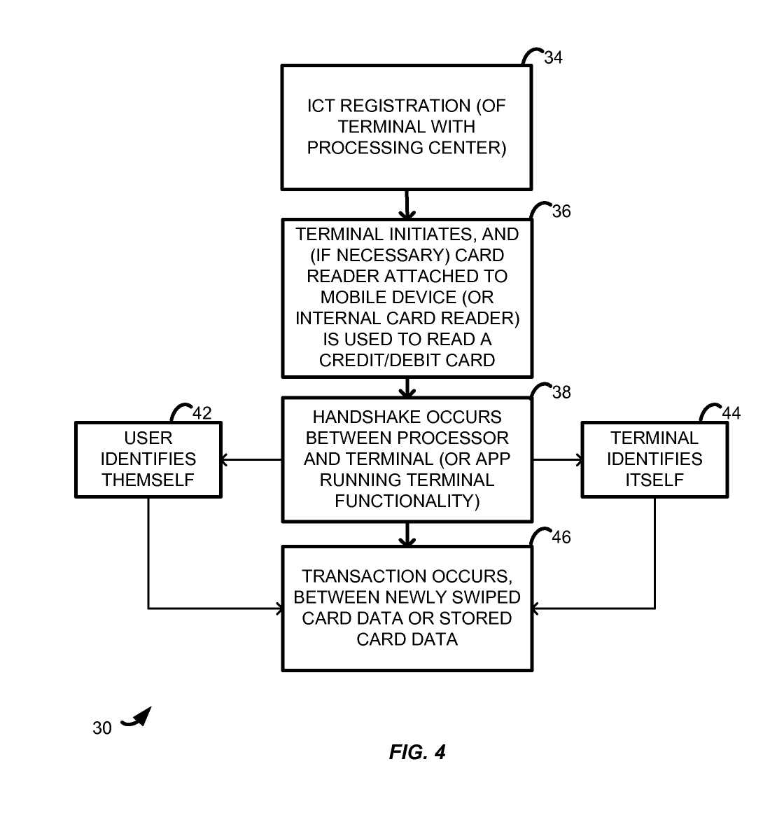

Referring to FIG. 4, additional security may be afforded by a dual security handshaking protocol which may be employed in certain implementations. In particular, after an initial ICT registration step (when the same is first set up) (step 34), an individual transaction may be started by initiating the terminal application on the mobile device. A handshaking step may then occur (step 38) in which both the user identifies and/or authenticates themselves with the processor and also with the terminal application (which generally also uses with a PIN pad (physical or implemented in software and a touchscreen interface) and a card reader as noted above). If either one or the other fails to authenticate, then the system and method may not work to successfully complete a transaction. In this way, even if the phone or a card reader module is lost or stolen, the system will remain secure, as another means of authentication is still required before a transaction can be initiated.

As additional security, if the ICT 24 or mobile device 29 is lost or misplaced, and then is attempted to be opened, magnets or other security devices may be situated within the device to wipe the memory chip.

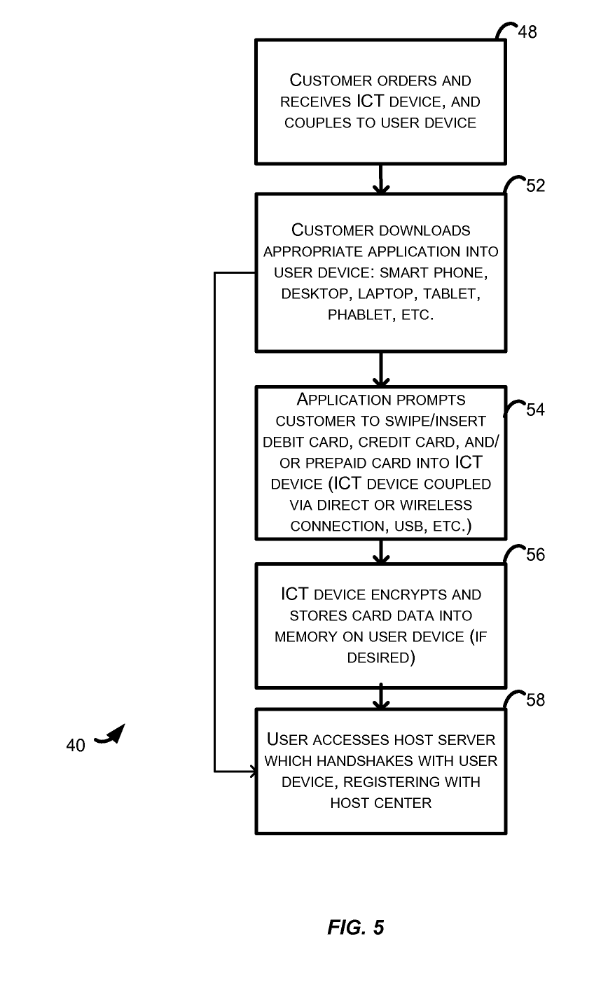

FIG. 5 illustrates a flowchart 40 which may be employed for a method for a user to become affiliated with a hosting server. In a first step, a user orders and receives an ICT device, e.g., ICT device 24 above, and couples the same to a user device such as a smart phone, desktop computer, tablet computer, laptop computer, phablet, or the like (step 48). The user then downloads an appropriate application into the user device (step 52). The user may then use the application to access a host server and register the mobile device and/or ICT device with the host server.

Alternatively, the application may require a card swipe first. That is, the application may prompt the customer to couple the ICT device to the user device (if not previously so coupled) and to swipe or insert a desired card into the ICT device (step 54). The ICT device then encrypts and stores the card data into memory on the user device (step 56), and/or on the ICT device. The user may then access a host center which handshakes with the user device, registering the user, e.g., a user account associated with the user device and/or the ICT device, with a host center (step 58).

Upon registration the user may be prompted to enter an identifier which is then associated with the user account. In use, the user may instantiate the application on their mobile device, enter their username and password, and then as an extra layer of security enter their identifier for each transaction (or transactions may be grouped within a time period, and the user prompted to enter their identifier just once per time period).

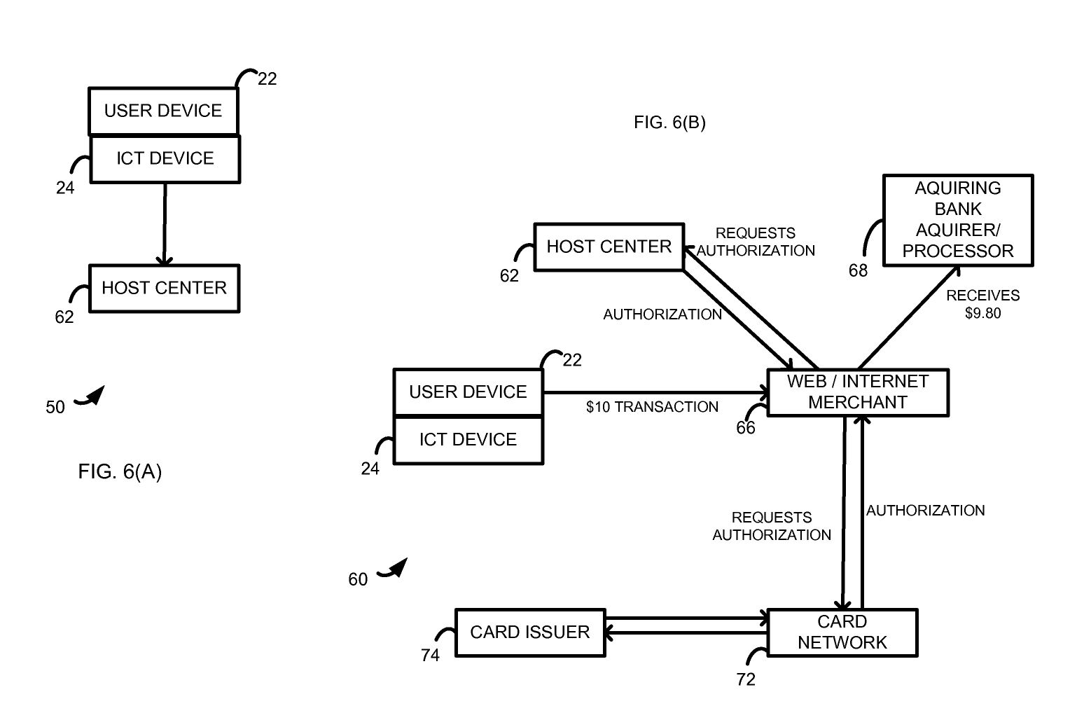

FIG. 6 illustrates an even more detailed implementation 50 of present principles. In the implementation of the diagram 50 of FIG. 6(A), a user device 22 (desktop or laptop computer, tablet computer, mobile device including smart phone, etc.) coupled with an ICT device 24 has established an affiliation with a host server 62, e.g., using the method of FIG. 5. The configuration of the user device 22 and ICT device 24 may be by any of the ways noted above. Using the method of FIG. 5, the device registers with a host server 62, and a mac address of the device becomes associated with the user account within the host server 62. From that point on, in subsequent communications, the host server 62 may detect the mac address and in this way at least in part identify the user device 22 and ICT device 24.

The diagram 60 of FIG. 6(B) then illustrates the flow of a transaction. The user device 22 with ICT device 24 conducts a transaction at a web merchant 66. In FIG. 6(B), a $10 transaction is illustrated between the user device and the web merchant 66. Upon implementation of systems and methods according to present principles, the user may be prompted to enter their username and password, as well as their identifier number, e.g., the four or six digit number noted above (such identifiers may take numerous other forms as will be understood). The ICT device 24 may encrypt the card data, as well as any other entered data, and transmit the encrypted data to the hosting center 62, which can decrypt the data or send it to another service for decryption. In sending the encrypted data from the web merchant 66 to the host center 62, the web merchant 66 is requesting authorization of the transaction from the hosting center. And in so doing, the hosting center provides a measure of security because the same must authorize the transaction for the same to proceed.

Once such authorization is received from the host center 62, the remainder of the transaction may be carried out in known fashion, e.g., through a card network 72 and a card issuer (issuing bank) 74, with eventual settlement being by way of the acquirer/processor (acquiring bank) 68 settling transactions to the various parties. As part of this procedure, the acquirer/processor gets the authorization of the card from the issuer through the interchange.

What has been described are systems and methods for implementing storefront point-of-sale techniques with mobile consumer systems, allowing superior security for internet and web merchant commerce. Variations will be understood. For example, credit or debit card data may be stored on the mobile device or some users may prefer swiping their card every time for added security, e.g., in case of well a lost or misplaced mobile device. However, such practice entails carrying a card reader whenever the device is to be used. Systems and methods according to present principles may be conveniently offered as a payment mechanism within an internet or web commerce site.

The methods shown and described above may be implemented in one or more general, multi-purpose, or single-purpose processors. Unless specifically stated, the methods described herein are not constrained to a particular order or sequence. In addition, some of the described methods or elements thereof can occur or be performed concurrently.

Functions/components described herein as being computer programs are not limited to implementation by any specific embodiments of computer programs. Rather, such functions/components are processes that convey or transform data, and may generally be implemented by, or executed in, hardware, software, firmware, or any combination thereof.

It will be appreciated that particular configurations of the operating environment may include fewer, more, or different components or functions than those described. In addition, functional components of the operating environment may be implemented by one or more devices, which are co-located or remotely located, in a variety of ways.

Although the subject matter herein has been described in language specific to structural features and/or methodological acts, it is also to be understood that the subject matter defined in the claims is not necessarily limited to the specific features or acts described above. Rather, the specific features and acts described above are disclosed as example forms of implementing the claims.

It will further be understood that when one element is indicated as being responsive to another element, the elements may be directly or indirectly coupled. Connections depicted herein may be logical or physical in practice to achieve a coupling or communicative interface between elements. Connections may be implemented, among other ways, as inter-process communications among software processes, or inter-machine communications among networked computers.

The word “exemplary” is used herein to mean serving as an example, instance, or illustration. Any implementation or aspect thereof described herein as “exemplary” is not necessarily to be construed as preferred or advantageous over other implementations or aspects thereof.

The system and method may be fully implemented in any number of computing devices. Typically, instructions are laid out on computer readable media, generally non-transitory, and these instructions are sufficient to allow a processor in the computing device to implement the method of the invention. The computer readable medium may be a hard drive or solid state storage having instructions that, when run, are loaded into random access memory. Inputs to the application, e.g., from the plurality of users or from any one user, may be by any number of appropriate computer input devices. For example, users may employ a keyboard, mouse, touchscreen, joystick, trackpad, other pointing device, or any other such computer input device to input data relevant to the calculations. Data may also be input by way of an inserted memory chip, hard drive, flash drives, flash memory, optical media, magnetic media, or any other type of file—storing medium. The outputs may be delivered to a user by way of a video graphics card or integrated graphics chipset coupled to a display that may be seen by a user. Given this teaching, any number of other tangible outputs will also be understood to be contemplated by the invention. For example, outputs may be stored on a memory chip, hard drive, flash drives, flash memory, optical media, magnetic media, or any other type of output. It should also be noted that the invention may be implemented on any number of different types of computing devices, e.g., personal computers, laptop computers, notebook computers, net book computers, handheld computers, personal digital assistants, mobile phones, smart phones, tablet computers, and also on devices specifically designed for these purpose. In one implementation, a user of a smart phone or WiFi—connected device downloads a copy of the application to their device from a server using a wireless internet connection. An appropriate authentication procedure and secure transaction process may provide for payment to be made to the seller. The application may download over the mobile connection, or over the WiFi or other wireless network connection. The application may then be run by the user. Such a networked system may provide a suitable computing environment for an implementation in which a plurality of users provide separate inputs to the system and method. In the above system where credit card transactions are contemplated, the plural inputs may allow plural users to input relevant data at the same time.

As it is understood that embodiments other than the specific embodiments described above may be devised without departing from the spirit and scope of the appended claims, it is intended that the scope of the subject matter herein will be governed by the following claims.

1. A device for performing online commerce in a secure fashion, comprising:
a. an internet consumer terminal module device, configured to signally couple to a mobile device, the internet consumer terminal module device configured to transmit credit or debit card data to a credit card processor upon a transaction conducted by the mobile device with an online merchant;
b. wherein the internet consumer terminal module device further includes a physical chip configured to encrypt credit or debit card data to a level sufficient for the credit card processor to complete the transaction.

2. The device of claim 1, wherein the chip is a DES chip.

3. The device of claim 2, wherein the encryption includes DUKPT.

4. The device of claim 1, further comprising a card reader formed integrally with the internet consumer terminal module device.

5. The device of claim 1, wherein the internet consumer terminal module device further comprises a port configured to attach to a card reader.

6. The device of claim 1, further comprising means for input of a personal identification code.

7. The device of claim 6, wherein the means is a user interface of the internet consumer terminal module device.

8. The device of claim 6, wherein the means is a user interface of the mobile device.

9. The device of claim 6, wherein the means includes a port for a detachable pin pad.

10. A device for performing online commerce in a secure fashion, comprising:
a. a mobile device including an internet consumer terminal module, the mobile device configured to transmit credit or debit card data to a credit card processor upon a transaction conducted by the mobile device with an online merchant;
b. wherein the internet consumer terminal module further includes a physical chip configured to encrypt credit or debit card data to a level sufficient for the credit card processor to complete the transaction.

11. The device of claim 10, wherein the chip is a DES chip.

12. The device of claim 11, wherein the encryption includes DUKPT.

13. The device of claim 10, further comprising a card reader formed integrally with the mobile device.

14. The device of claim 10, wherein the mobile device further comprises a port configured to attach to a card reader.

15. The device of claim 10, further comprising means for input of a personal identification code.

16. The device of claim 15, wherein the means is a user interface of the mobile device.

17. The device of claim 15, wherein the means includes a port for a detachable pin pad.

18. A method for performing online commerce in a secure fashion using a consumer mobile device, comprising:
a. using the device of claim 1, identifying and authenticating a user with the internet consumer terminal module device;
b. using the same device, identifying and authenticating the internet consumer terminal module device with a credit card processor server;
c. if both authentications are successful, allowing the internet consumer terminal module device to complete a transaction with the credit card processor server.

19. A method for performing online commerce in a secure fashion using a consumer mobile device, comprising:
a. using the device of claim 10, identifying and authenticating a user with the mobile device;
b. using the same device, identifying and authenticating the mobile device with a credit card processor server;
c. if both authentications are successful, allowing the mobile device to complete a transaction with the credit card processor server.

20. A method for enabling the performance of online commerce in a secure fashion using a hosting server in communication with a plurality of consumer mobile devices, comprising:
a. on a hosting server, identifying and authenticating a user employing a device according to claim 1;
b. receiving an encrypted request for an authorization for a transaction from an Internet merchant, the transaction requested by the user;
c. decrypting the request, or causing the decryption of the request;
d. determining if the requested transaction should proceed; and
e. transmitting the determination from the hosting server to the Internet merchant.

21. A method for enabling the performance of online commerce in a secure fashion using a hosting server in communication with a plurality of consumer mobile devices, comprising:
a. on a hosting server, identifying and authenticating a user employing a device according to claim 10;
b. receiving an encrypted request for an authorization for a transaction from an Internet merchant, the transaction requested by the user;
c. decrypting the request, or causing the decryption of the request;
d. determining if the requested transaction should proceed; and
e. transmitting the determination from the hosting server to the Internet merchant.
